(19) United States
(12) Patent Application Publication
(10) Pub. No.: US 2025/0171019 A1
(43) Pub. Date: May 29, 2025

(54) VEHICLE DRIVING ASSISTANCE APPARATUS

(71) Applicant: TOYOTA JIDOSHA KABUSHIKI KAISHA, Toyota-shi (JP)

(72) Inventors: Soichi OKUBO, Okazaki-shi (JP); Noriaki KAMIYA, Nagoya-shi (JP)

(73) Assignee: TOYOTA JIDOSHA KABUSHIKI KAISHA, Toyota-shi (JP)

(21) Appl. No.: 18/924,163

(22) Filed: Oct. 23, 2024

(30) Foreign Application Priority Data
Nov. 28, 2023 (JP) 2023-200994

(51) Int. Cl. B60W 30/14; B60W 30/16; B60W 50/00

(52) U.S. Cl. CPC B60W 30/143; B60W 30/16; B60W 50/0097; B60W 2552/30; B60W 2554/802

(57) ABSTRACT

A vehicle driving assistance apparatus maintains a vehicle moving speed of an own vehicle at a set speed when the vehicle moving speed becomes greater than the set speed while maintaining an inter-vehicle distance at a set distance by a following moving control, and executes a deceleration assistance control when the vehicle moving speed becomes greater than a predetermined upper limit speed. When (i) a speed limit condition that the speed limit applied to the own vehicle is predicted to become small and (ii) a set vehicle moving speed change condition that the vehicle moving speed cannot be maintained at a speed equal to or smaller than the speed limit predicted to become small by the deceleration assistance control, become satisfied, the apparatus changes the set speed to a speed equal to or smaller than the speed limit predicted to become small.

### CROSS-REFERENCE TO RELATED APPLICATIONS

This application claims priority to Japanese patent application No. JP 2023-200994 filed on Nov. 28, 2023, the content of which is hereby incorporated by reference in its entirety.

### BACKGROUND

### Field

The present invention relates to a vehicle driving assistance apparatus.

### Description of the Related Art

There is known a vehicle driving assistance apparatus that executes a following moving control to maintain an inter-vehicle distance between an own vehicle and a preceding vehicle at a set inter-vehicle distance. In addition, there is also known a vehicle driving assistance apparatus that executes a deceleration assistance control to decelerate the own vehicle when a vehicle moving speed of the own vehicle becomes greater than a predetermined upper limit vehicle moving speed when the own vehicle is moving on a curved road while the following moving control is executed (see, for example, JP 2017-43193 A).

When the following moving control is executed, a speed limit applied to the own vehicle may become small. When the speed limit applied to the own vehicle becomes small, if the deceleration assistance control is executed, the vehicle is decelerated, but there is a possibility that the vehicle moving speed of the own vehicle is not maintained at the speed limit or smaller.

### SUMMARY

The object of the present invention is to provide a vehicle driving assistance apparatus that can maintain the vehicle moving speed of the own vehicle at the speed limit or smaller when the speed limit applied to the own vehicle is predicted to become small.

A vehicle driving assistance apparatus according to the present invention comprises an electronic control unit which executes a following moving control to maintain an inter-vehicle distance between an own vehicle and a preceding vehicle at a set inter-vehicle distance. The electronic control unit is configured to maintain a vehicle moving speed of the own vehicle at a set vehicle moving speed when the vehicle moving speed of the own vehicle becomes greater than the set vehicle moving speed while maintaining the inter-vehicle distance at the set inter-vehicle distance by the following moving control, and execute a deceleration assistance control to decelerate the own vehicle when the vehicle moving speed of the own vehicle becomes greater than a predetermined upper limit vehicle moving speed. Further, when (i) a speed limit condition that the speed limit applied to the own vehicle is predicted to become small and (ii) a set vehicle moving speed change condition that the vehicle moving speed of the own vehicle cannot be maintained at a speed equal to or smaller than the speed limit predicted to become small by the deceleration assistance control, become satisfied, the electronic control unit is configured to change the set vehicle moving speed to a speed equal to or smaller than the speed limit predicted to become small.

According to the vehicle driving assistance apparatus of the present invention, when the speed limit applied to the own vehicle is predicted to become small, and the vehicle moving speed of the own vehicle cannot be maintained at or below the speed limit predicted to become small by the deceleration assistance control, the set vehicle moving speed is changed to a vehicle moving speed equal to or below the smaller speed limit. Therefore, even when the speed limit applied to the own vehicle becomes smaller, the vehicle moving speed of the own vehicle can be maintained at or below the speed limit.

In the vehicle driving assistance apparatus according to an aspect of the present invention, the deceleration assistance control may be a control of decelerating the own vehicle when the vehicle moving speed of the own vehicle becomes greater than the predetermined upper limit vehicle moving speed when the own vehicle is moving on a curved road. In this case, the speed limit condition may be a condition that the speed limit applied to the own vehicle is predicted to become small, and the current set vehicle moving speed is greater than the speed limit predicted to become small. Further, in this case, the electronic control unit may be configured to predict that the speed limit applied to the own vehicle becomes small when the own vehicle is predicted to move on the curved road and the curved road is a deceleration request section in which the speed limit smaller than the speed limit currently applied to the own vehicle is applied to the own vehicle.

According to the vehicle driving assistance apparatus of this aspect of the present invention, when the following moving control is executed, the own vehicle may move on the curved road. When the own vehicle enters the curved road, the speed limit applied to the own vehicle becomes smaller. In this situation, when the vehicle moving speed of the own vehicle cannot be maintained at or below the smaller speed limit by the deceleration assistance control, and the current set vehicle moving speed is greater than the speed limit predicted to become small, the set vehicle moving speed is changed to a vehicle moving speed equal to or below the speed limit predicted to become small. Therefore, even when the own vehicle enters the curved road and the speed limit applied to the own vehicle becomes small, the vehicle moving speed of the own vehicle can be maintained at or below the speed limit predicted to become small.

Further, in the vehicle driving assistance apparatus according to another aspect of the present invention, the electronic control unit may be configured to restore the current set vehicle moving speed to the original set vehicle moving speed when the own vehicle has passed the deceleration request section. In this case, the original set vehicle moving speed may be the set vehicle moving speed set before the own vehicle enters the deceleration request section.

According to the vehicle driving assistance apparatus of this aspect of the present invention, after the own vehicle has passed the deceleration request section, the set vehicle moving speed is restored to the original set vehicle moving speed. Therefore, the own vehicle can be moved using the appropriate set vehicle moving speed.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a diagram showing a vehicle driving assistance apparatus according to an embodiment of the present invention.

FIG. 2 is a diagram showing a scene where a preceding vehicle is present.

FIG. 3 is a diagram showing a scene where the preceding vehicle is not present.

FIG. 4 is a flowchart showing a routine executed by the vehicle driving assistance apparatus according to the embodiment of the present invention.

FIG. 5 is a diagram showing a junction of a highway.

### DETAILED DESCRIPTION

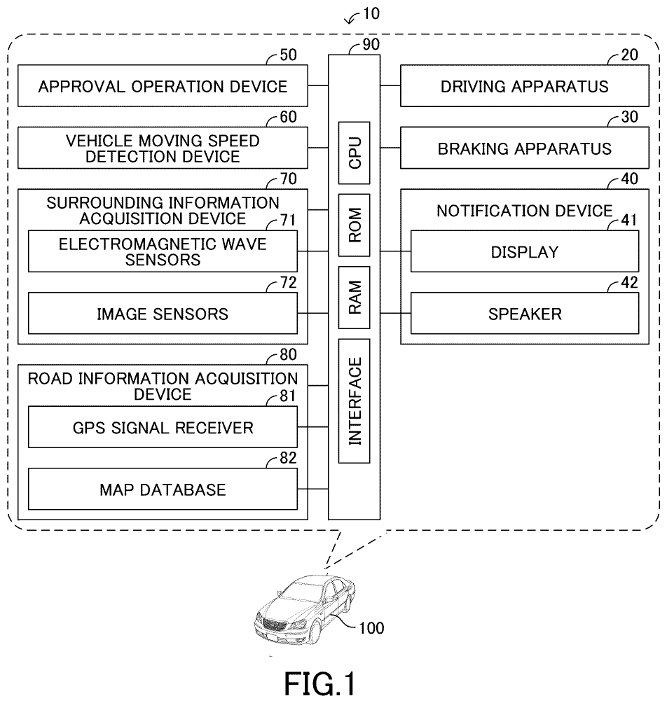

Below, a vehicle driving assistance apparatus according to an embodiment of the present invention will be described with reference to the drawings. FIG. 1 illustrates the vehicle driving assistance apparatus 10 according to the embodiment of the present invention. The vehicle driving assistance apparatus 10 is mounted on an own vehicle 100. Hereinafter, the vehicle driving assistance apparatus 10 will be described by exemplifying a situation where an operator of the own vehicle 100 is a driver of the own vehicle 100, that is, a person who rides on the own vehicle 100 and drives the own vehicle 100.

However, the operator of the own vehicle 100 may be a remote operator of the own vehicle 100, i.e., a person who is not in the own vehicle 100 but remotely drives the own vehicle 100. When the operator of the own vehicle 100 is the remote operator, the vehicle driving assistance apparatus 10 is mounted on the own vehicle 100 and a remote control facility installed outside the own vehicle 100 for remotely driving the own vehicle 100, respectively and functions realized by the vehicle driving assistance apparatus 10 described below are shared by the vehicle driving assistance apparatus 10 mounted on the own vehicle 100 and the vehicle driving assistance apparatus 10 mounted on the remote control facility.

As illustrated in FIG. 1, the vehicle driving assistance apparatus 10 includes an ECU 90 as a control device. ECU is an electronic control unit. The ECU 90 includes a microcomputer as a main component. The microcomputer includes a CPU, a computer-readable storage medium such as a ROM, a RAM and a non-volatile memory, an interface, and the like. The CPU is configured or programmed to realize various functions by executing instructions, programs, or routines stored in the storage medium. In particular, in the present embodiment, the vehicle driving assistance apparatus 10 stores programs of realizing various controls executed by the vehicle driving assistance apparatus 10 in the storage medium.

In the present embodiment, the vehicle driving assistance apparatus 10 includes only one ECU 90, but may include a plurality of the ECUs, and may be configured to share the functions realized by the vehicle driving assistance apparatus 10 described below by the respective ECU.

In addition, the vehicle driving assistance apparatus 10 may be configured to update the programs stored in the storage medium by wireless communication (for example, internet communication) with external devices.

As shown in FIG. 1, the own vehicle 100 is equipped with a driving apparatus 20, a braking apparatus 30, and a notification device 40.

The driving apparatus 20 is an apparatus that generates a driving force applied to the own vehicle 100. The driving apparatus 20 comprises, for example, an internal combustion engine and/or at least one electric motor. The driving apparatus 20 is electrically connected to the ECU 90. By controlling an operation of the driving apparatus 20, the vehicle driving assistance apparatus 10 controls the driving force applied to the own vehicle 100 to accelerate or decelerate the own vehicle 100.

The braking apparatus 30 is an apparatus that applies a braking force to the own vehicle 100. The braking apparatus 30 includes, for example, a hydraulic brake apparatus. The braking apparatus 30 is electrically connected to the ECU 90. The vehicle driving assistance apparatus 10 applies the braking force to the own vehicle 100 to decelerate the own vehicle 100 by controlling an operation of the braking apparatus 30.

The notification device 40 is a device that makes various notifications to the driver of the own vehicle 100. In the present embodiment, the notification device 40 includes a display 41 and a speaker 42.

The display 41 is a device that displays various images. The display 41 is electrically connected to the ECU 90. The vehicle driving assistance apparatus 10 displays various images on the display 41.

The speaker 42 is a device that outputs various announcements. The speaker 42 is electrically connected to the ECU 90. The vehicle driving assistance apparatus 10 outputs various announcements from the speaker 42.

Further, the own vehicle 100 is equipped with an approval operation device 50, a vehicle moving speed detection device 60, a surrounding information acquisition device 70, and a road information acquisition device 80.

The approval operation device 50 is a device operated by the driver of the own vehicle 100, and is attached to, for example, a steering wheel of the own vehicle 100. The driver can perform an approval operation described later by operating the approval operation device 50. The approval operation device 50 is electrically connected to the ECU 90. When the approval operation device 50 is operated, the vehicle driving assistance apparatus 10 determines that the approval operation is performed.

The vehicle moving speed detection device 60 is a device that detects a vehicle moving speed of the own vehicle 100. The vehicle moving speed detection device 60 includes, for example, wheel rotation speed sensors attached to respective wheels of the own vehicle 100. The vehicle moving speed detection device 60 is electrically connected to the ECU 90. The vehicle driving assistance apparatus 10 acquires the moving vehicle moving speed of the own vehicle 100 as an own vehicle moving speed V by the vehicle moving speed detection device 60.

The surrounding information acquisition device 70 is a device that acquires information on situations around the own vehicle 100. In the present embodiment, the surrounding information acquisition device 70 includes electromagnetic wave sensors 71 and image sensors 72.

The electromagnetic wave sensor 71 is a sensor that acquires information on objects existing around the own vehicle 100. The electromagnetic wave sensor 71 is, for example, a millimeter wave radar. The electromagnetic wave sensors 71 are electrically connected to the ECU 90. The vehicle driving assistance apparatus 10 acquires, by the electromagnetic wave sensors 71, the information on the objects (for example, a preceding vehicle) existing around the own vehicle 100 as surrounding information IS (or sensor information ISsensor).

The image sensor 72 is a sensor that captures and acquires images of views around the own vehicle 100. The image sensor 72 is, for example, a camera. The image sensors 72 are electrically connected to the ECU 90. The vehicle driving assistance apparatus 10 acquires the images of the views around the own vehicle 100 as the surrounding information IS (or image information IScamera) by the image sensors 72.

The road information acquisition device 80 is a device that acquires information on a road around the own vehicle 100 (for example, a speed limit applied to the own vehicle 100). In the present embodiment, the road information acquisition device 80 includes a GPS signal receiver 81 and a map database 82.

The GPS signal receiver 81 is a device that receives GPS signals. The GPS signal receiver 81 is electrically connected to the ECU 90. The vehicle driving assistance apparatus 10 receives the GPS signals via the GPS signal receiver 81, and acquires a present position of the own vehicle 100 based on the received GPS signals.

The map database 82 is a device that stores map information. The map database 82 is electrically connected to the ECU 90. The vehicle driving assistance apparatus 10 acquires information on a road ahead of the own vehicle 100 (for example, the speed limit applied to the own vehicle 100) as the surrounding information IS (or road information ISroad) from the present position of the own vehicle 100 acquired as described above and the map information stored in the map database 82.

### <Operations of Vehicle Driving Assistance Apparatus>

Next, operations of the vehicle driving assistance apparatus 10 will be described.

The vehicle driving assistance apparatus 10 executes a driving assistance control as an automatic driving control. In the present embodiment, the driving assistance control includes a following moving control (or an adaptive cruise control), a constant speed moving control (or a cruise control), and a deceleration assistance control.

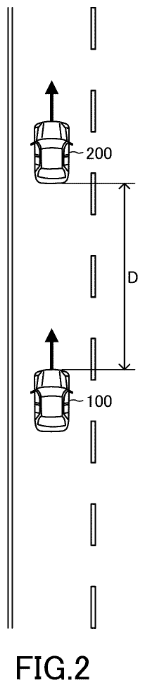

As illustrated in FIG. 2, the following moving control is a control of autonomously accelerating or decelerating the own vehicle 100 so that an inter-vehicle distance D (i.e., a distance between the preceding vehicle 200 and the own vehicle 100) is maintained at a predetermined distance (or a set inter-vehicle distance Dset) when the preceding vehicle 200 is present. That is, the following moving control is a control of maintaining the vehicle-to-vehicle distance D, which is the distance between the own vehicle 100 and the preceding vehicle 200, at the set inter-vehicle distance Dset.

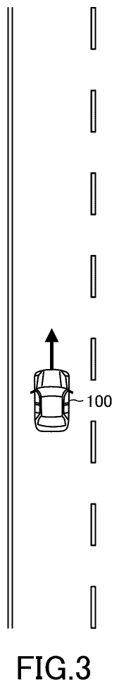

As illustrated in FIG. 3, the constant speed moving control is a control of autonomously accelerating or decelerating the own vehicle 100 so that the own vehicle moving speed V is maintained at a predetermined vehicle moving speed (or set vehicle moving speed Vset) when the preceding vehicle 200 is not present.

When the following moving control is executed, the vehicle driving assistance apparatus 10 accelerates the own vehicle 100 when the inter-vehicle distance D becomes greater than the set inter-vehicle distance Dset. On the other hand, when the following moving control is executed, the vehicle driving assistance apparatus 10 decelerates the own vehicle 100 when the inter-vehicle distance D becomes smaller than the set inter-vehicle distance Dset. Thereby, the vehicle driving assistance apparatus 10 maintains the inter-vehicle distance D at the set inter-vehicle distance Dset.

When the own vehicle moving speed V increases to the set vehicle moving speed Vset when the following moving control is executed, the vehicle driving assistance apparatus 10 autonomously accelerates or decelerates the own vehicle 100 so that the own vehicle moving speed V is maintained at the set vehicle moving speed Vset. For example, the vehicle driving assistance apparatus 10 autonomously accelerates or decelerates the own vehicle 100 so that the own vehicle moving speed V is maintained at the set vehicle moving speed Vset when the own vehicle moving speed V increases the set vehicle moving speed Vset while the own vehicle 100 is accelerating when the following moving control is executed. Therefore, the vehicle driving assistance apparatus 10 is configured to maintain the own vehicle moving speed V at the set vehicle moving speed Vset when the own vehicle moving speed V becomes greater than the set vehicle moving speed Vset in order to maintain the inter-vehicle distance D at the set inter-vehicle distance Dset when the following moving control is executed.

In addition, the vehicle driving assistance apparatus 10 accelerates the own vehicle 100 when the own vehicle moving speed V becomes smaller than the set vehicle moving speed Vset when the constant speed moving control is executed. On the other hand, the vehicle driving assistance apparatus 10 decelerates the own vehicle 100 when the own vehicle moving speed V becomes greater than the set vehicle moving speed Vset when the constant speed moving control is executed. Thereby, the vehicle driving assistance apparatus 10 maintains the own vehicle moving speed V at the set vehicle moving speed Vset.

The vehicle driving assistance apparatus 10 is configured to determine whether or not the preceding vehicle 200 is present based on the surrounding information IS (in particular, the sensor information ISsensor). Further, the vehicle driving assistance apparatus 10 acquires the inter-vehicle distance D based on the surrounding information IS (in particular, the sensor information ISsensor).

Further, the deceleration assistance control is a control of autonomously decelerating the own vehicle 100 so that the own vehicle moving speed V is maintained below a predetermined upper limit vehicle moving speed Vupper when the own vehicle 100 is moving on a curved road.

The vehicle driving assistance apparatus 10 autonomously decelerates the own vehicle 100 so that the own vehicle moving speed V is maintained below the upper limit vehicle moving speed Vupper when the own vehicle moving speed V increases to the predetermined upper limit vehicle moving speed Vupper while the own vehicle 100 is moving on the curved road.

That is, the deceleration assistance control is a control of decelerating the own vehicle 100 when the own vehicle moving speed V becomes greater than the predetermined upper limit vehicle moving speed Vupper when the own vehicle 100 moves on the curved road. In the present invention, the deceleration assistance control may be a control of decelerating the own vehicle 100 when the own vehicle moving speed V becomes greater than the predetermined upper limit vehicle moving speed Vupper even when the own vehicle 100 is not moving on the curved road. That is, the deceleration assistance control may be a control of decelerating the own vehicle 100 when the own vehicle moving speed V becomes greater than the predetermined upper limit vehicle moving speed Vupper.

The predetermined upper limit vehicle moving speed Vupper is an upper limit of the own vehicle moving speed V at which the own vehicle 100 can stably move on the curved road in view of a curvature of the curved road on which the own vehicle 100 moves. The vehicle driving assistance apparatus 10 is configured to acquire the curvature of the curved road on which the own vehicle 100 moves based on the surrounding information IS (in particular, the image information IScamera) and/or the road information ISroad.

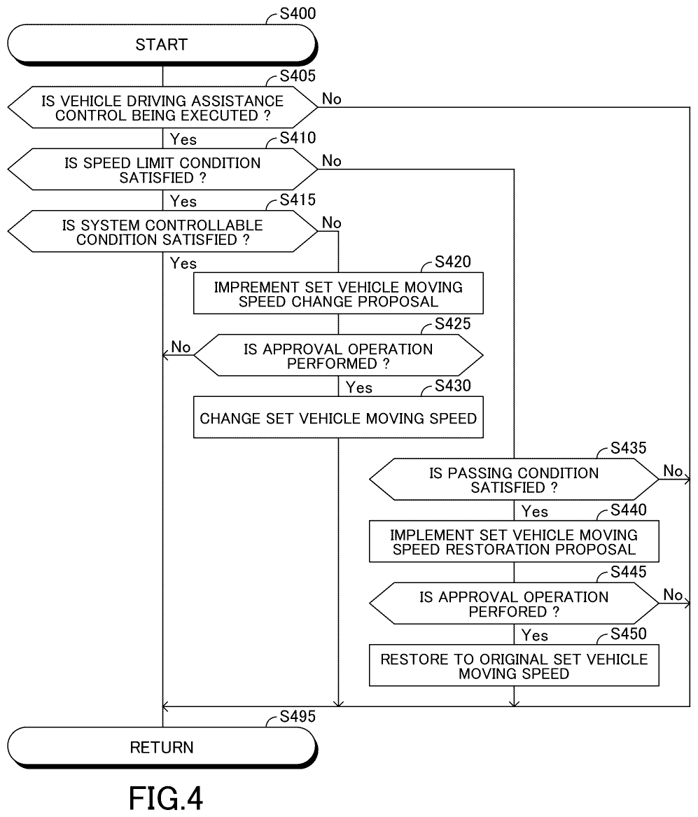

Further, the vehicle driving assistance apparatus 10 executes a routine illustrated in FIG. 4 at predetermined time intervals. By executing the routine shown in FIG. 4, the vehicle driving assistance apparatus 10 makes a proposal for reducing the set vehicle moving speed Vset to the driver of the own vehicle 100 when a predetermined condition is satisfied, and reduces the set vehicle moving speed Vset when the driver performs an approval operation on the proposal.

When the predetermined timing is reached, the vehicle driving assistance apparatus 10 starts a process from a step S400 of the routine shown in FIG. 4 and proceeds with the process to a step S405 to determine whether or not the driving assistance control is being executed.

When the driving assistance control is not being executed, the vehicle driving assistance apparatus 10 determines “No” at the step S405 ad proceeds with the process directly to a step S495 to terminate executing this routine once.

On the other hand, when the driving assistance control is being executed, the vehicle driving assistance apparatus 10 determines “Yes” at the step S405 and proceeds with the process to the step S410 to determine whether or not a speed limit condition C1 is satisfied.

The speed limit condition C1 is a condition that the speed limit Vlimit applied to the own vehicle 100 is predicted to become small. In particular, the speed limit condition C1 is a condition that the own vehicle 100 is predicted to move in a deceleration request section 300. More specifically, the speed limit condition C1 is a condition that the speed limit Vlimit applied to the own vehicle 100 is predicted to become small and the present set vehicle moving speed Vset is greater than the speed limit Vlimit predicted to become small. In other words, the speed limit condition C1 is a condition that the own vehicle 100 is predicted to move in the deceleration request section 300, the deceleration request section 300 exists in front of the own vehicle 100 within a predetermined range Dth, and the speed limit Vlimit applied to the own vehicle 100 in the deceleration request section 300 is smaller than the present set vehicle moving speed Vset. Alternatively, the speed limit condition C1 is a condition that the own vehicle 100 is predicted to move in the deceleration request section 300 in a predetermined period Tth, and the speed limit Vlimit applied to the own vehicle 100 in the deceleration request section 300 is smaller than the present set vehicle moving speed Vset.

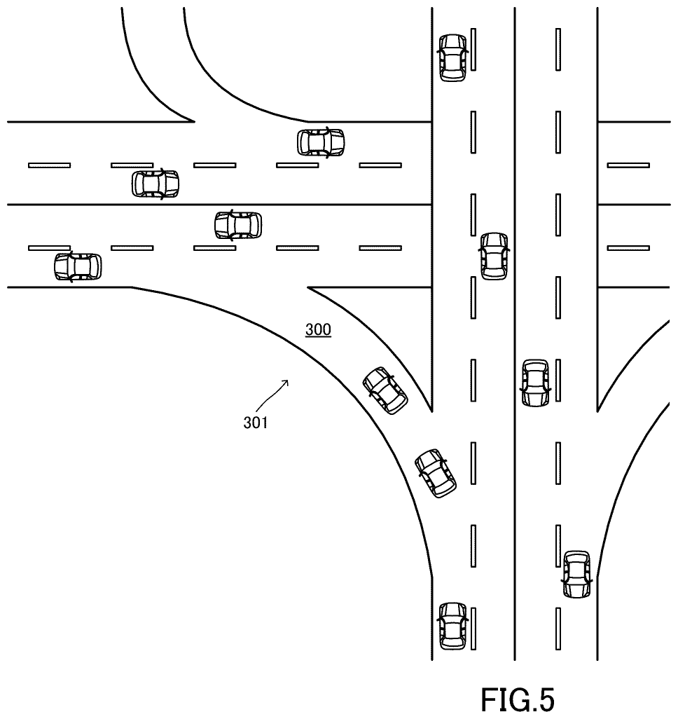

The deceleration request section 300 is a section in which the own vehicle 100 is applied with the speed limit Vlimit smaller than the speed limit Vlimit currently applied to the own vehicle 100. The deceleration request section 300 is, for example, a section of the curved road such as a connection road at a junction 301 of an expressway as illustrated in FIG. 5.

When the speed limit condition C1 is satisfied (that is, when the speed limit Vlimit applied to the own vehicle 100 is predicted to become small), the vehicle driving assistance apparatus 10 determines “Yes” at the step S410 and proceeds with the process to a step S415 to determine whether or not a system controllable condition C2 is satisfied.

The system controllable condition C2 is a condition that the own vehicle moving speed V can be maintained below the speed limit Vlimit applied to the own vehicle 100 by the deceleration assistance control when the own vehicle 100 is moving in the deceleration request section 300.

When the system controllable condition C2 is satisfied, the vehicle driving assistance apparatus 10 determines “Yes” at the step S415 and proceeds with the process to the step S495 to terminate executing this routine once. Therefore, in this case, a set vehicle moving speed change proposal is not implemented. The set vehicle moving speed change proposal proposes to reduce the set vehicle moving speed Vset from the present set vehicle moving speed Vset. In particular, the set vehicle moving speed change proposal proposes setting the speed limit Vlimit applied to the own vehicle 100 in the deceleration request section 300 as the set vehicle moving speed Vset.

In the present embodiment, the vehicle driving assistance apparatus 10 implements the set vehicle moving speed change proposal by the notification device 40. More specifically, the vehicle driving assistance apparatus 10 implements the set vehicle moving speed change proposal by displaying images suggesting to reduce the set vehicle moving speed Vset on the display 41 and/or outputting announcements suggesting to reduce the set vehicle moving speed Vset from the speaker 42.

On the other hand, when the system controllable condition C2 is not satisfied, the vehicle driving assistance apparatus 10 determines “No” at the step S415 and proceeds the process to a step S420 to implement the set vehicle moving speed change proposal. Next, the vehicle driving assistance apparatus 10 proceeds with the process to a step S425 to determine whether or not the driver performs the approval operation for the set vehicle moving speed change proposal. The approval operation is an operation performed by the driver on the approval operation device 50.

When the approval operation is not performed, the vehicle driving assistance apparatus 10 determines “No” at the step S425 and proceeds with the process to the step S495 to terminate executing this routine once.

On the other hand, when the approval operation is performed, the vehicle driving assistance apparatus 10 determines “Yes” at the step S425 and proceeds with the process to a step S430 to set the speed limit Vlimit applied to the own vehicle 100 in the deceleration request section 300 as the set vehicle moving speed Vset. That is, the vehicle driving assistance apparatus 10 reduces the set vehicle moving speed Vset. At this time, the vehicle driving assistance apparatus 10 terminates implementing the set vehicle moving speed change proposal.

Next, the vehicle driving assistance apparatus 10 proceeds with the process to the step S495 to terminate executing this routine once.

When the speed limit condition C1 is not satisfied at the time when the process is advanced to the step S410 (that is, when the speed limit Vlimit applied to the own vehicle 100 is not predicted to become small), the vehicle driving assistance apparatus 10 determines “No” at the step S410 and proceeds with the process to a step S435 to determine whether or not a passing condition C3 is satisfied. The passing condition C3 is a condition that the own vehicle 100 has passed the deceleration request section 300. More specifically, the passing condition C3 is a condition that the own vehicle 100 has passed the deceleration request section 300 and the speed limit Vlimit applied to the own vehicle 100 has returned to the original speed limit Vlimit applied to the own vehicle 100 prior to entering the deceleration request section 300. The vehicle driving assistance apparatus 10 is configured to determine whether or not the passing condition C3 is satisfied based on the surrounding information IS and/or the road-information ISroad.

When the passing condition C3 is not satisfied, the vehicle driving assistance apparatus 10 determines “No” at the step S435 and proceeds the process to the step S495 to terminate executing this routine once.

On the other hand, when the passing condition C3 becomes satisfied, the vehicle driving assistance apparatus 10 determines “Yes” at the step S435 and proceeds with the process to a step S440 to implement a set vehicle moving speed restoration proposal. The set vehicle moving speed restoration proposal proposes to restore the set vehicle moving speed Vset to the original set vehicle moving speed Vset. More specifically, the set vehicle moving speed restoration proposal proposes to restore the set vehicle moving speed Vset to the set vehicle moving speed Vset prior to being reduced at the step S430.

In the present embodiment, the vehicle driving assistance apparatus 10 implements the set vehicle moving speed restoration proposal by the notification device 40. More specifically, the vehicle driving assistance apparatus 10 implements the set vehicle moving speed restoration proposal by displaying on the display 41 images suggesting restoring the set vehicle moving speed Vset to the original set vehicle moving speed Vset and/or outputting the announcements from the speaker 42 suggesting restoring the set vehicle moving speed Vset to the original set vehicle moving speed Vset.

Next, the vehicle driving assistance apparatus 10 proceeds with the process to a step S445 to determine whether or not the driver performs the approval operation on the set vehicle moving speed restoration proposal.

When the approval operation is not performed, the vehicle driving assistance apparatus 10 determines “No” at the step S445 and proceeds with the process to the step S495 to terminate executing this routine once.

On the other hand, when the approval operation is performed, the vehicle driving assistance apparatus 10 determines “Yes” at the step S445 and proceeds the process to a step S450 to set the original set vehicle moving speed Vset as the set vehicle moving speed Vset. At this time, the vehicle driving assistance apparatus 10 terminates implementing the set vehicle moving speed restoration proposal.

Next, the vehicle driving assistance apparatus 10 proceeds with the process to the step S495 to terminate executing this routine once.

The operations of the vehicle driving assistance apparatus 10 have been described.

According to the vehicle driving assistance apparatus 10, when it is predicted that the speed limit Vlimit applied to the own vehicle 100 becomes small, and the own vehicle moving speed V cannot be maintained at the moving vehicle moving speed equal to or smaller than the speed limit Vlimit predicted to become small by the deceleration assistance control, the set vehicle moving speed Vset is changed to the moving vehicle moving speed equal to or smaller than the speed limit Vlimit predicted to become small. Therefore, even if the speed limit Vlimit applied to the own vehicle 100 becomes small, the own vehicle moving speed V can be maintained at the vehicle moving speed equal to or smaller than the speed limit Vlimit.

Note that the present invention is not limited to the above-described embodiments, and various modifications can be adopted within the scope of the present invention.

For example, in the above-described embodiment, the vehicle driving assistance apparatus 10 sets the speed limit Vlimit applied to the own vehicle 100 in the deceleration request section 300 as the set vehicle moving speed Vset at the step S430 of the routine illustrated in FIG. 4. However, the vehicle driving assistance apparatus 10 may be configured to set any vehicle moving speed smaller than the speed limit Vlimit applied to the own vehicle 100 in the deceleration request section 300 as the set vehicle moving speed Vset at the step S430.

Further, the step S420 and the step S425 of the routine illustrated in FIG. 4 may be omitted. That is, the vehicle driving assistance apparatus 10 may be configured to, when the speed limit condition C1 is satisfied but the system controllable condition C2 is not satisfied when the driving assistance control is executed, set the speed limit Vlimit applied to the own vehicle 100 in the deceleration request section 300 as the set vehicle moving speed Vset without implementing the set vehicle moving speed change proposal.

That is, the vehicle driving assistance apparatus 10 may be configured to, when a set vehicle moving speed change condition at least including (i) the speed limit condition C1 that the speed limit Vlimit applied to the own vehicle 100 is predicted to become small, is satisfied, and (ii) the system controllable condition C2 that the own vehicle moving speed V can be maintained at the moving vehicle moving speed equal to or smaller than the speed limit Vlimit predicted to become small by the deceleration assistance control, is not satisfied, change the set vehicle moving speed Vset to the moving vehicle moving speed equal to or smaller than the speed limit Vlimit predicted to become small.

Further, the step S440 and the step S445 of the routine illustrated in FIG. 4 may be omitted. That is, when the passing condition C3 is satisfied when the driving assistance control is executed, the vehicle driving assistance apparatus 10 may be configured to restore the set vehicle moving speed Vset to the original set vehicle moving speed Vset applied to the own vehicle 100 prior to the own vehicle 100 entering the deceleration request section 300 without implementing the set vehicle moving speed restoration proposal.

That is, when the own vehicle 100 has passed the deceleration request section 300, the vehicle driving assistance apparatus 10 may be configured to restore the set vehicle moving speed Vset to the original set vehicle moving speed Vset prior to the own vehicle 100 entering the deceleration request section 300.

What is claimed is:

1. A vehicle driving assistance apparatus, comprising an electronic control unit which executes a following moving control to maintain an inter-vehicle distance between an own vehicle and a preceding vehicle at a set inter-vehicle distance,
the electronic control unit being configured to:
maintain a vehicle moving speed of the own vehicle at a set vehicle moving speed when the vehicle moving speed of the own vehicle becomes greater than the set vehicle moving speed while maintaining the inter-vehicle distance at the set inter-vehicle distance by the following moving control; and
execute a deceleration assistance control to decelerate the own vehicle when the vehicle moving speed of the own vehicle becomes greater than a predetermined upper limit vehicle moving speed,
wherein when (i) a speed limit condition that the speed limit applied to the own vehicle is predicted to become small and (ii) a set vehicle moving speed change condition that the vehicle moving speed of the own vehicle cannot be maintained at a speed equal to or smaller than the speed limit predicted to become small by the deceleration assistance control, become satisfied, the electronic control unit is configured to change the set vehicle moving speed to a speed equal to or smaller than the speed limit predicted to become small.

2. The vehicle driving assistance apparatus according to claim 1,
wherein the deceleration assistance control is a control of decelerating the own vehicle when the vehicle moving speed of the own vehicle becomes greater than the predetermined upper limit vehicle moving speed when the own vehicle is moving on a curved road,
wherein the speed limit condition is a condition that the speed limit applied to the own vehicle is predicted to become small, and the current set vehicle moving speed is greater than the speed limit predicted to become small, and
wherein the electronic control unit is configured to predict that the speed limit applied to the own vehicle becomes small when the own vehicle is predicted to move on the curved road and the curved road is a deceleration request section in which the speed limit smaller than the speed limit currently applied to the own vehicle is applied to the own vehicle.

3. The vehicle driving assistance apparatus according to claim 2,
wherein the electronic control unit is configured to restore the current set vehicle moving speed to the original set vehicle moving speed when the own vehicle has passed the deceleration request section, and
wherein the original set vehicle moving speed is the set vehicle moving speed set before the own vehicle enters the deceleration request section.
